(19) United States
(12) Patent Application Publication
(10) Pub. No.: US 2009/0116013 A1
(43) Pub. Date: May 7, 2009

(54) Apparatus for alignment of optical elements in an array

(75) Inventors: Lawrence Tom, Sunnyvale, CA (US); Stephen J. Horne, El Granada, CA (US); Mark James Spencer, San Jose, CA (US)

Correspondence Address: Trellis Intellectual Property Law Group, PC, 1900 EMBARCADERO ROAD, SUITE 109, PALO ALTO, CA, 94303, US

(73) Assignee: Sol Focus, Inc., Palo Alto, CA (US)

(21) Appl. No.: 11/546,270

(22) Filed: Oct. 11, 2006

Related U.S. Application Data
(60) Provisional application No. 60/837,405, filed on Aug. 11, 2006.

(51) Int. Cl. G01B 11/27

(52) U.S. Cl. 356/399

(57) ABSTRACT

Apparatus for fabricating an array of aligned optical elements. A base tool is used to receive and align a planar material such as a glass sheet. A template tool is used to deposit secondary mirrors and adhesive patches onto the glass sheet. The adhesive patches are used to receive and mount primary mirrors. The primary mirrors are selectively held by an assembly tool. The primary mirrors are brought into alignment with the glass sheet by using actuators on the base tool and by using a registration mechanism to align the assembly tool with the glass sheet.

### CLAIM OF PRIORITY

This application claims priority from U.S. Provisional Patent Application Ser. No. 60/837,405 filed on Aug. 11, 2006 entitled “Photovoltaic Array Using Concentrators” which is hereby incorporated by reference as if set forth in full in this application for all purposes.

### RELATED APPLICATIONS

This application is related to co-pending U.S. Utility Patent Application Ser. No. [TBD] filed on Oct. 11, 2006 entitled “Method for Alignment of Optical Elements in an Array” which is hereby incorporated by reference as if set forth in full in this application for all purposes.

### Background Of The Invention

This invention relates in general to alignment of optical elements and more specifically to alignment of arrays of optical elements for focusing sunlight on corresponding photovoltaic cells.

Solar energy has long held great promise to the solution of the world's energy problems. However, in order to build a solar system that can compete with other energy options it is necessary to lower the cost per watt of solar energy from what is obtainable by today's approaches. Some factors that are critical to lowering the cost per watt include improving the efficiency of a solar energy system, reducing the cost and increasing the lifetime of the system.

One approach to a solar energy system uses panels or arrays of photovoltaic cells. In a flat-plate, or “direct,” type of design the cells are placed to cover an area upon which direct sunlight falls. In a “concentrator” type of design optical elements such as mirrors and lenses are used to concentrate sunlight to a smaller, focused area that is occupied by one or more cells. In these approaches, solar cells and any of their associated optical elements are replicated into identical assemblies and arranged into arrays on panels.

The concentrator type of design can provide benefits, especially when the cost of the photovoltaic cell is high, since fewer cells are used per unit area of the array. The higher the ratio of concentration, the fewer cells need to be used. As the concentration of the sunlight onto a cell increases, it becomes more and more important that the concentration be accurate to cover as exactly as possible the entire active surface of the cell. In this respect, accurate alignment of the optical elements of each assembly becomes increasingly important.

### SUMMARY OF EMBODIMENTS OF THE INVENTION

Embodiments of the invention provide devices and systems for fabricating an array of aligned optical elements. In one embodiment, a template tool is used to position an array of secondary mirrors on a surface, and also to deposit adhesive for receiving an array of primary mirrors in alignment with the secondary mirrors. The template tool includes: a planar sheet; a first set of through holes in the planar sheet, wherein the through holes in the first set are used to position secondary mirrors onto a surface by using the planar sheet as a template; and a second set of through holes in the planar sheet, wherein the second set of through holes includes groups of through holes, wherein each group of through holes is associated with a different hole in the first set, wherein the through holes in a particular group in the second set are used to position adhesive patches in a predetermined relationship to a corresponding secondary mirror placed onto the surface using the planar sheet.

In another embodiment, a base tool is used to bring components of an optical array into alignment. The base tool includes a registration mechanism for ensuring alignment of tools, materials, components, and other items during an assembly process. The base tool includes: a first registration mechanism for registering a material having a surface, wherein the first registration mechanism also provides for registering a template in alignment with the material, wherein the template provides for depositing a plurality of first optical elements and for determining a mounting position for a plurality of second optical elements; and a second registration mechanism for registering an assembly in alignment with the material, wherein the assembly deposits the second optical elements in a predetermined alignment with at least one first optical elements according to the determined mounting positions.

In another embodiment, an assembly tool is used to selectively hold primary mirrors for depositing onto a surface in alignment with secondary mirrors. The assembly tool includes: means for selectively holding a plurality of primary mirror to the apparatus; and means for registering the plurality of primary mirrors to a plurality of secondary mirrors.

In another embodiment, a fabrication system provides an apparatus for aligning optical components for use in a photovoltaic array, the apparatus including: a base tool for receiving a sheet of material; a template tool for depositing a plurality of secondary mirrors onto the sheet of material and for depositing adhesive patches onto the sheet of material for securing primary mirrors, wherein each primary mirror is associated with a different one of the secondary mirrors; and an assembly tool for selectively holding the primary mirrors, wherein the base tool includes a mechanism to bring the assembly tool into alignment with the sheet of material.

### BRIEF DESCRIPTION OF THE DRAWINGS

FIG. 1 shows details of a base tool;

FIG. 2A illustrates relationships of the base tool, glass sheet, template tool and assembly tool in an overview of the fabrication process;

FIG. 2B shows a more detailed view of layers in the fabrication process described in FIG. 2A;

FIG. 2C shows an enlarged view of an actuator;

FIG. 3 shows details of a template tool;

FIG. 4 shows details of an assembly tool;

FIG. 5A illustrates details of placement of the primary mirror;

FIG. 5B shows a cutaway view of depositing a primary mirror onto adhesive patches;

FIG. 6 shows details of a back pan tool and assembly;

FIG. 7A illustrates a sequential assembly line;

FIG. 7B illustrates a robotic assembly line; and

FIG. 8 is a simplified flowchart illustrating basic steps in a fabrication process.

### DETAILED DESCRIPTION OF EMBODIMENTS OF THE INVENTION

A particular embodiment provides apparatus for fabricating an array of photovoltaic cells using optically aligned primary and secondary mirrors. The array design is described in detail in related, co-pending patent applications as follows:

1. “Concentrator Solar Photovoltaic Array with Compact Tailored Imaging Power Units;” Ser. No. 11/138,666; filed May 26, 2005; and

2. “Optical System Using Tailored Imaging Designs;” Serial No. Ser. No. 11/351,314; filed Feb. 9, 2006, which claims priority from U.S. provisional patent application 60/651,856 filed Feb. 10, 2005.

The above two utility and one provisional applications are hereby incorporated by reference as if set forth in full in this application for all purposes.

Note that variations on the array design described in the related application may be achieved by modifying specific steps and/or items described herein while still remaining within the scope of the invention as claimed.

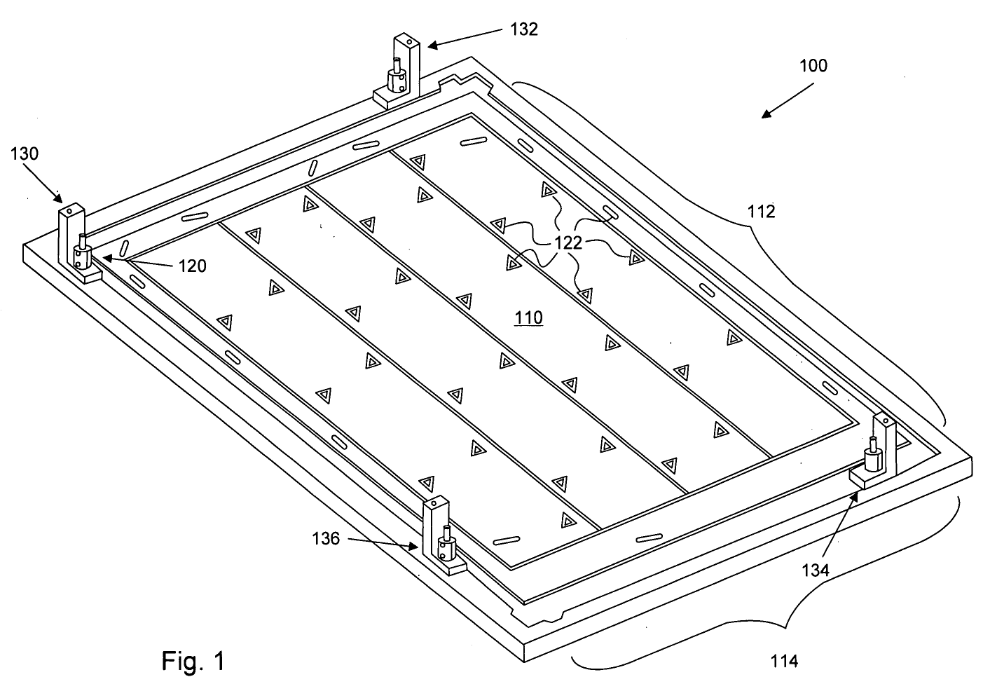

FIG. 1 illustrates base tool 100 for receiving a sheet of glass as a first step in a fabrication process. Although specific details of items such as objects, materials, actions, etc., are presented herein it is possible to vary, substitute or omit details or items and still achieve benefits of the invention. For example, any type of transparent or transmissive planar sheet other than glass (e.g., plastic, polycarbonate, etc.) can be suitable for use with the methods described herein. Also, any suitable type of glass (e.g., coated, multiple layer, safety glass, etc.) can be used.

Top surface 110 of the bottom panel of base tool 100 is shown facing up from the page of the Figure. This top surface is the top surface of a transparent polycarbonate sheet that forms the clear bottom of the base tool. In a particular embodiment, the bottom panel of base tool 100 is transparent to allow for optional inspection and testing of the array as it is being constructed or after construction. For example, a light source placed below top surface 110 can be used to illuminate components of the array. The reflections, refractions, or other optical characteristics of illumination off of components in the array can be measured. In other embodiments, the bottom panel of base tool 100 need not be transparent. It can be opaque or can have different degrees of transparency to different wavelengths of energy. The extents of the polycarbonate sheet are shown approximately as width 112 and height 114. The polycarbonate sheet is secured to the rigid frame of base tool 100 such that a sheet of rectangular glass of approximately the same dimensions as the polycarbonate sheet placed onto top surface 110 can be positioned to abut lower-left corner 120 of the raised inside edges of the frame of the base tool.

The abutting of the glass to the corner of the base tool acts to register the glass in place with respect to the tool. Other approaches can use registration of different parts of the glass. Optical or other detectable markings can be used such as fiducial marks on the glass itself. Such an alternative embodiment is discussed in more detail below in association with an automated assembly line production. Subsequent steps performed using the base tool register additional tools, materials and items to achieve alignment of optical components as described below. Note that other suitable means of registering the glass to the base tool are possible. For example, multiple points along the edges of the glass sheet can be placed into or against corresponding points of the frame or against other surfaces, structures or mechanisms that are fixed with respect to the frame. In other embodiments, the sheet of glass need not be rectangular and can be of any arbitrary shape.

Markings such as 122 are included on the polycarbonate sheet as visual aids to an operator placing the glass sheet. These markings show where adhesive will later be deposited upon the glass and can be useful, for example, to make sure that the glass sheet is large enough to cover all the marking and will thus successfully receive all of the desired adhesive locations. Actuators 130, 132, 134 and 136 are located about the periphery on the frame of the base tool and are used to lower subsequent tools into registration with the glass sheet.

The five parallel horizontal lines running along the width of the polycarbonate sheet, and the two vertical lines at the ends of the vertical lines, are vacuum channels for holding the glass sheet to the polycarbonate sheet during the fabrication process. The apparatus for applying a vacuum is not shown but any suitable apparatus can be used. In some tool designs, close-fit tolerances on the edges of the sheet, use of friction and/or gravity, etc. may be sufficient to hold the glass sheet in place in a fixed relationship to the base tool.

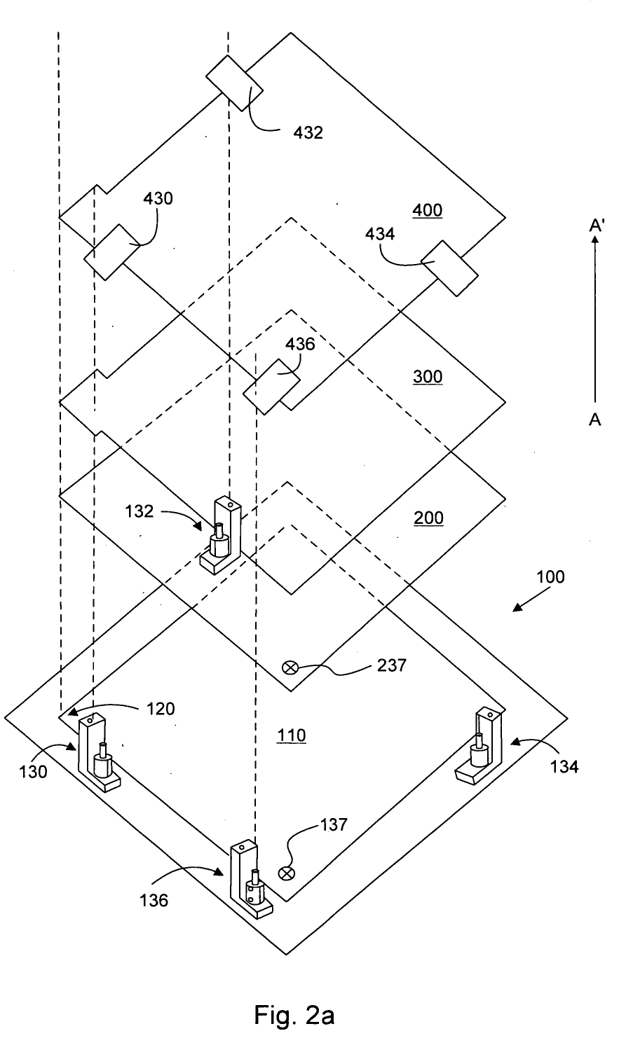

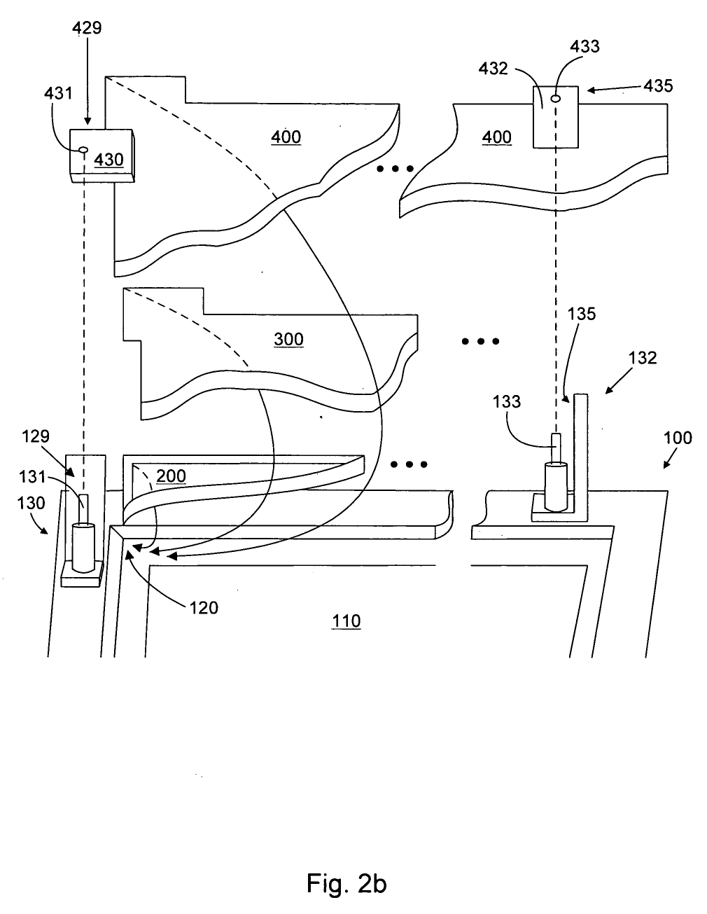

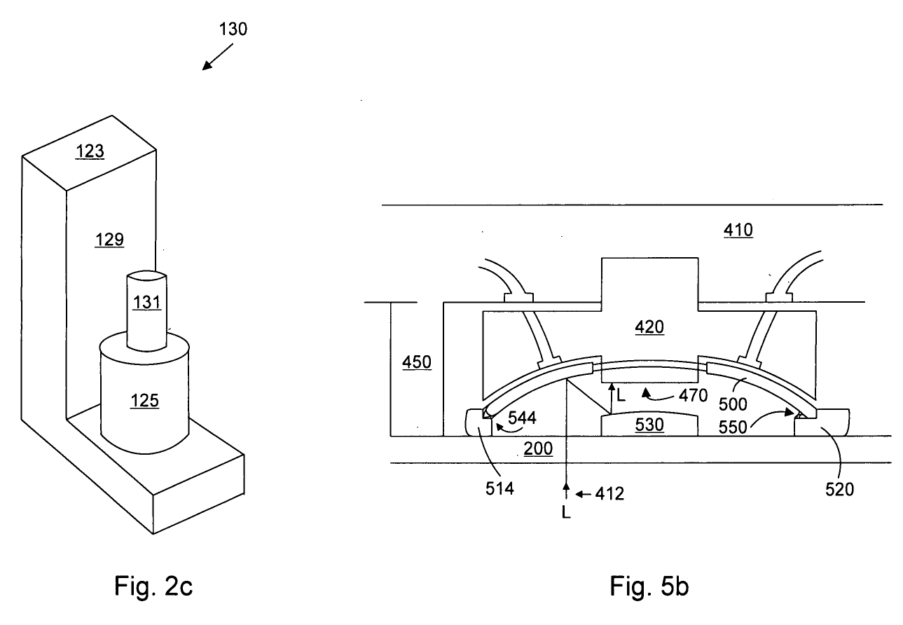

FIG. 2A illustrates the relationships of base tool 100, glass sheet 200, template tool 300 and assembly tool 400. The diagram of FIG. 2A merely shows the order of application of the glass sheet and tools in order to achieve basic steps of a fabrication procedure according to a particular embodiment of the invention. Many details have been omitted and the sizes and distances shown are not to scale.

In the actual fabrication process a first step involves setting up base tool 100 in a stationary and level fixed position with respect to the ground. The direction A-A′ up from the page is the direction away from the Earth's center of gravity. This orientation of the tools can provide advantages. For example, in testing or aligning other components it is possible to use the direction of gravity to assist in the alignment. Also, as will be shown below, securing the optical components to the glass sheet is more accurate with the face up, level positioning of the base tool. However, in other embodiments it is possible, and may be desirable, to have the base tool (and other tools) in a different orientation with respect to gravitational direction. For example, the base tool may face in the opposite direction and the subsequent steps described below can be reversed. Or the base tool can be inclined or normal to the gravitational direction (i.e., top surface 110 parallel to the gravitational direction) if materials are used that have properties (e.g., malleability, fluid flow characteristics, etc.) so that the optical alignment might benefit from non-uniform formations due to gravitational forces applied at an angle to the plane of the array. In gravity-free (or near free) applications, other orientations of the tools can be used to other advantages. For example, in a free-fall, or weightless environment the base tool, and other tools and materials, may be oriented in an arbitrary position.

A particular embodiment uses tool and part dimensions suitable to receive a glass sheet of approximately 1113 mm by 1336 mm so that the tools, materials and completed array are comparable in dimension. However, these dimensions can be changed, as desired. Note that although the invention is described with respect to macro-scale assemblies and construction, that aspects of the invention may also be applied to micro or nano-scale applications such as are used in Micro-Electromechanical Systems (MEMS).

Returning to FIG. 2A, once base tool 100 is secured, a next step in the fabrication requires placement of glass sheet 200 onto top surface 110 of the base tool. Placement in a particular embodiment is manual but automated or semi-automated steps can also be used for the placement of the glass sheet. Glass sheet 200 is registered at lower-left corner 120 of base tool 100.

Next template tool 300 is placed onto glass sheet 200. Template tool 300 is also registered at lower-left corner 120 of base tool 100. Template tool 300 is used to deposit and secure secondary mirrors (not shown) and also to place adhesive for mounting primary mirrors, as discussed below. Once the primary mirrors are secured and the adhesive for the secondary mirrors is deposited the template tool is removed from the glass sheet.

As a next step, assembly tool 400 is applied with primary mirrors (not shown) and placed so that tabs 430, 432 and 436 rest on the supporting rods of their corresponding actuators 130, 132 and 136, respectively. The edge of each tab abuts against the pillar face of the tab's corresponding actuator as shown by the dotted lines in FIG. 2A. Note that the fourth actuator 134 and its corresponding tab 434 are not used for registration but, instead, merely provide even support while lowering the assembly tool. Hence, there is no dotted line showing a registration relationship between actuator 134 and tab 434. In other embodiments different types of registration can be used, as can more or less registration points at different positions, as desired.

Alternative methods of registration may be used. For example, optical registration marks such as 137 and 237 on base tool 100 and glass sheet 200 can be used. Typically, multiple registration marks will be placed at different points on each sheet. If a mark is placed on a transparent surface, then manual or automated visual placement and alignment (i.e., registration) of the items is possible. Other types of registration may be used where the optical registration markings are replaced with mechanisms whose positions can be sensed with accuracy. For example, a magnetic indicator, pin or other mechanical structure, light source, energy emitter, etc. can be used as a registration mark that can be detected or sensed either manually, automatically or semi-automatically. Registration that is more susceptible to automation can be adapted for use with the assembly-line techniques, discussed below.

FIG. 2B shows a more detailed view of 4 layers used in the fabrication process described in FIG. 2A, including base tool 100, glass sheet 200, template tool 300 and assembly tool 400. The items in FIG. 2B are not to scale but are broken and fragmented in order to show details of registration with respect to two actuators, 130 and 132. Note that like numbered items in different Figures are used to denote the same item shown in two or more Figures.

FIG. 2C shows an enlarged view of actuator 130, as having supporting rod 131, actuating mechanism 125, pillar 123 and pillar face 129. Each actuator has a similar construction. In other designs, the actuators need not be identical and different types of actuators or mechanisms for causing registration and for bringing tools and items together can be employed.

As described above in the discussion of FIG. 1, glass sheet 200 is registered against the lower-left corner 120 of the raised frame of the base tool (note that the base tool is rotated clockwise by about 45 degrees in FIG. 2B from its orientation in FIG. 1). The arrow line from a corner of glass sheet 200 to a corner of base tool 100 indicates the registration.

Similarly, template tool 300 is registered on top of glass 200 at the same lower-left corner 120 of the base tool.

In the case of assembly tool 400, actuators 130, 132, 134 and 136 (not shown in FIG. 2B, see FIGS. 1 or 2A) are used to lower the assembly tool toward the base tool to cause registration with the base tool and glass sheet 200. As described below, template 300 is removed from glass sheet 200 well before back pan tool 400 is lowered and used. Referring to FIG. 2B, registration of back pan tool 400 uses tab edges 429 and 435 which are placed into contact with actuator pillar faces 129 and 135, respectively, so that points 431 and 433 are contacted by actuator posts 131 and 133, respectively. An additional similar set of tab edge and pillar face (not shown in FIG. 2) are used with actuator 136 of FIG. 1. A fourth actuator, 134, is shown in FIGS. 1 and 2A and is used to balance the position of back pan 400, but this fourth actuator is not used for registration.

In a preferred embodiment, the actuators are hydraulic and are ganged together, operated by one pressure device to slowly reduce pressure to cause all 4 supporting rods to move slowly downward in synchronization. Activation of the actuators is done manually by a human operator after manual placement of the back pan. In other embodiments, different numbers, placement or design of actuators can be used. For example, the actuators can be pneumatic, electromagnetic, etc. It should be apparent that processes or steps described herein as manual or automatic can be performed either manually or automatically or by a combination of both manual and automatic acts, as desired.

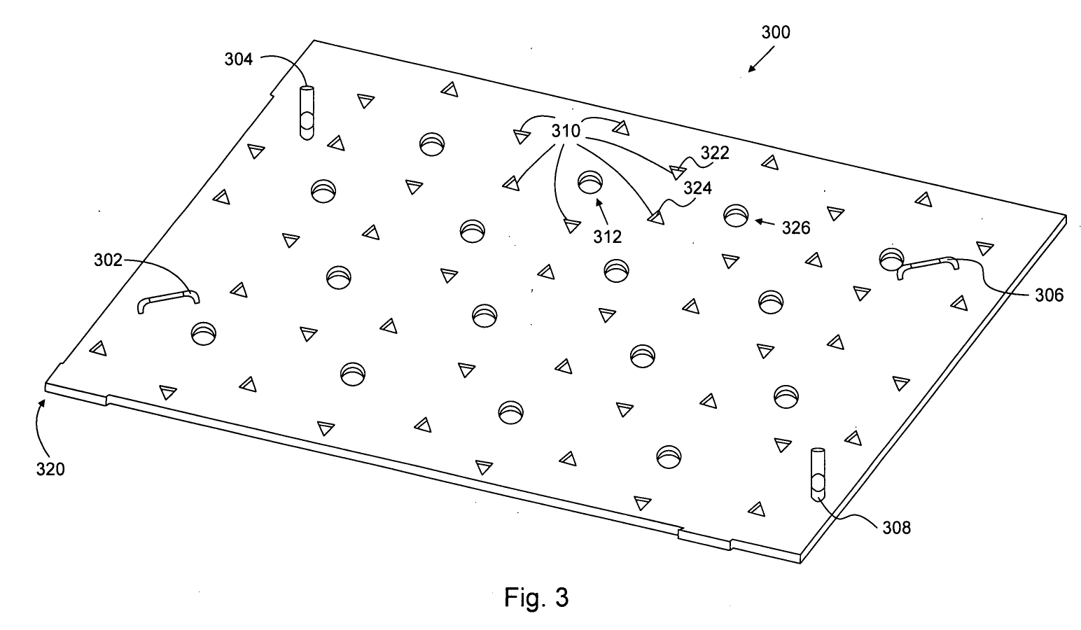

FIG. 3 shows details of template tool 300. Template tool 300 includes four handles 302, 304, 306 and 308 to allow placement by human operators of the template onto the glass sheet in registration with the base tool by mating the lower-left corner 320 of the template with the lower-left corner 120 of the base tool.

A basic pattern of cutouts is repeated 16 times on the template to correspond with the 16 array elements that will be built. Naturally, any number of elements can be used in other designs and details such as the placement, symmetry, shape, thickness and other dimensions of the template and cutouts can be changed, as desired. One example of a basic patter are the 6 adhesive cutouts 310 and secondary mirror cutout 312. Each cutout is a through-hole of precise positioning and tolerance. The adhesive cutouts are used to apply adhesive to the glass sheet and the secondary mirror cutout is used to apply adhesive and a secondary mirror to the glass sheet.

Many of the adhesive cutouts are shared by multiple elements in the array. For example, adhesive cutouts 322 and 324 are used by the element that includes secondary mirror cutout 312; and also by the element that includes secondary mirror cutout 326.

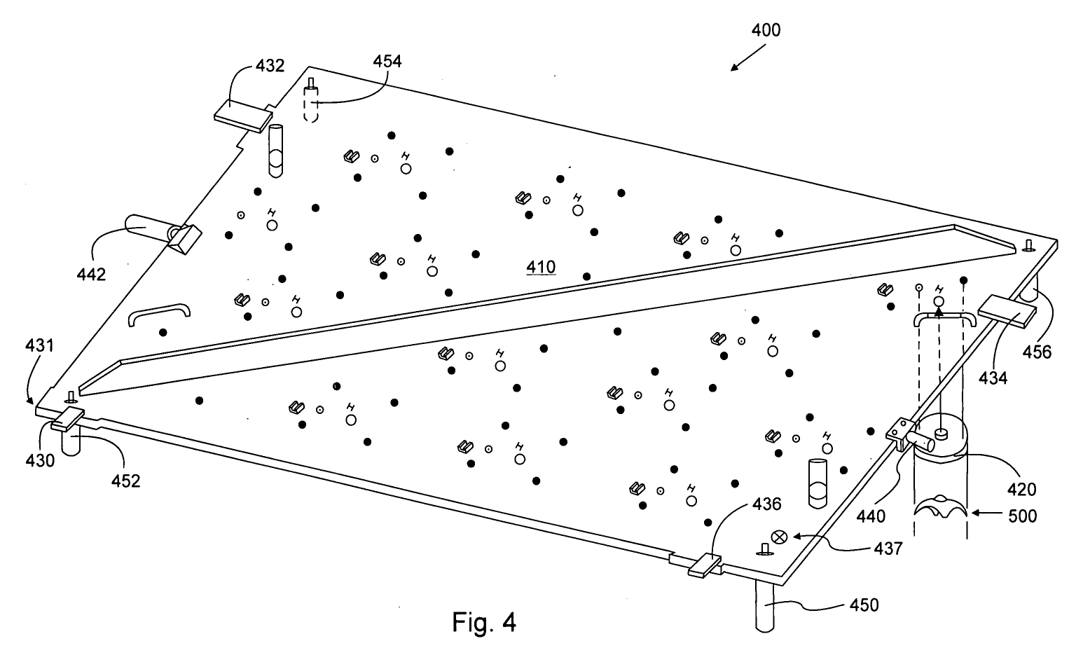

Details of the primary mirror design and materials, and of the adhesive used in a particular embodiment can be found in the related patent application referenced, above. FIG. 4 shows details of assembly tool 400. Assembly tool 400 includes panel 410 having 16 repeated patterns of through holes and hardware for mounting 16 mirror holders such as mirror holder 420. Only a single mirror holder is shown and it is not yet mounted to panel 410. Each mirror holder is designed to receive a primary mirror such as primary mirror 500. In a particular embodiment, the mirror holders are fitted with vacuum inlets to create an area of low pressure with respect to ambient atmospheric pressure. This low pressure causes the corresponding primary mirror to be detachably secured to the mirror holder under control of a human operator. Low pressure can be applied to inlets 440 and 442, for example. Such a system is readily known in the art and other suitable systems can be used to detachably couple mirrors to mirror holders and/or to an assembly tool of suitable design.

Assembly tool 400 includes tabs 430, 432, 434 and 436 for registering the assembly tool with the base tool as discussed above. In another embodiment, the assembly tool may be registered by other means such as manually, or automatically (e.g., optically, pin registration, magnetic or other sensing, etc.). When other registration methods are used the tabs can be omitted from the design. For example, if automated optical registration is used then a registration mark such as 437 can be used to line up with registration marks such as 137 , 237 (FIG. 2A) or other marks or registration mechanisms.

Assembly tool 400 also includes spacer posts 450, 452, 454 and 456 for providing a desired stand-off of the primary mirrors from the glass sheet and adhesive when the posts are brought into contact with the glass sheet as described, for example, in the final step presented in the discussion of FIG. 2A, above.

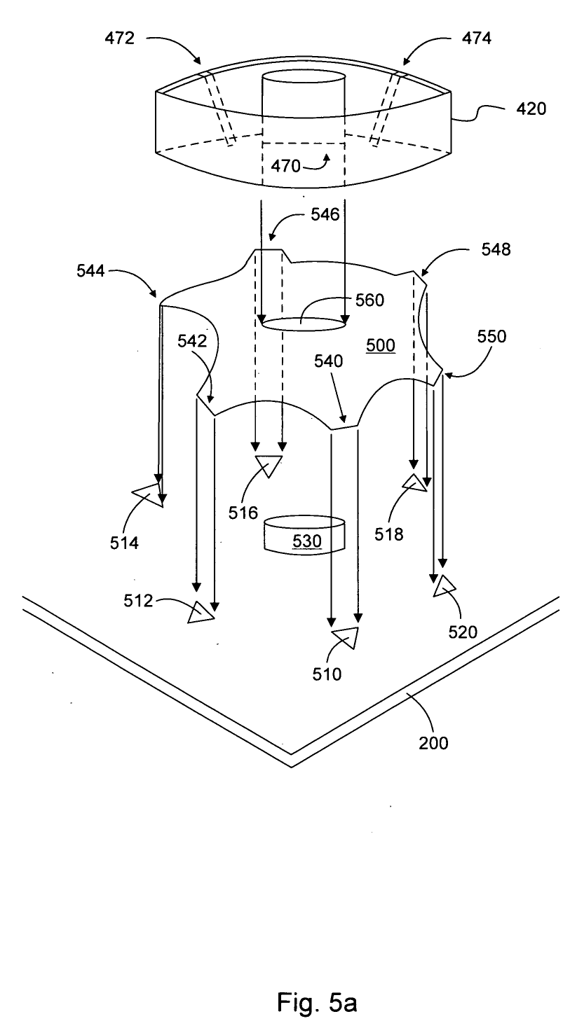

FIG. 5A illustrates details of placement of the primary mirror. In FIG. 5A, adhesive patches 510, 512, 514, 516, 518 and 520 have been applied to glass sheet 200 according to the method described above in connection with FIGS. 2A-C and FIG. 3. The adhesive patches correspond with the feet of primary mirror 500 as 540, 542, 544, 546, 548 and 550, respectively. Mirror holder 420 is used to align primary mirror 500 with secondary mirror 530. Alignment occurs because the three items: (1) glass sheet 200, (2) template tool 300 used to deposit the adhesive patches and secondary mirror, and (3) assembly tool 400 used to deposit the primary mirror; are each in registration with base tool 100.

Registration of primary mirror 500 with mirror holder 420 is facilitated with datum points created by spindle 470. Spindle 470 is attached to mirror holder 420 and is closely matched in size to the opening 560 in primary mirror 500. Vacuum outlets such as 472 and 474 are used to control depositing of the primary mirror onto the adhesive patches once assembly tool 400 is lowered into position. The vacuum is applied through panel 410 of assembly tool 400 and 16 primary mirrors are all deposited onto their corresponding adhesive patches at about the same time by releasing vacuum pressure to all holders at about the same time. However, in general, the timing of the deposit of items is not critical and other designs can perform depositing of any of the items described herein in parallel or serial, by use of one or more motions, steps or mechanisms.

FIG. 5B shows a cutaway view of structures used in a step of depositing a primary mirror onto adhesive patches. In FIG. 5B, primary mirror 500 includes feet 544 and 550. Additional feet of the primary mirror are not shown in this view, but are deposited in a similar manner to that described for feet 544 and 550. The sizes, distances and geometries of FIG. 5B are not to scale but are modified for ease of illustration of basic components and placement.

Feet 544 and 550 are positioned onto adhesive patches 514 and 520, respectively. Posts, such as post 450 (see, also, FIG. 4), stop the downward movement of assembly tool 400 at a predetermined height (e.g., approximately 1 mm in a particular embodiment) so that no actual contact of primary mirror 500 with glass sheet 200 occurs. The length of the posts is also designed so that there is sufficient contact of the feet of the primary mirrors with the adhesive so that secure bonding takes place. It is desirable to have an adhesive layer between the primary mirror and the glass sheet to serve as a flexible secure bond. The bond is intended to be a shear as well as a butt joint so there is adhesive on the sides of the mirror as well as the edge bonding it to the window.

Any suitable type of adhesive can be used. Adhesive families such as RTV, epoxies, silicones, acrylics, etc. can be employed. Any suitable type of curing or other process can be used such as anaerobic, ultraviolet, moisture, accelerators, etc. Spindles, such as spindle 470, fit closely through a hole in each spindle's associated primary mirror to ensure aligned placement of the two corresponding optical components, the primary and secondary mirrors, in each of the array elements that are provided in each of the tools.

A path of transmission and reflection of light is illustrated with light ray 412 as an example. Light ray 412 starts at L and travels in the upward direction to traverse glass sheet 200. When installed, the point L represents the origin of light or other energy being processed as, for example, from the sun. The array is positioned so that sunlight emanates from a direction, L, toward glass sheet 200.

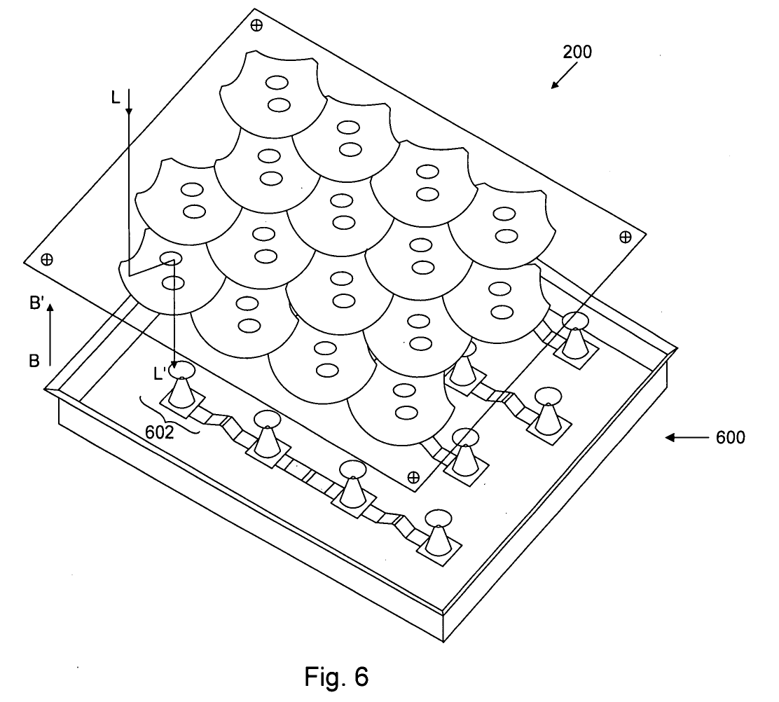

After passing through glass sheet 200, light ray 412 reflects off of primary mirror 500 toward secondary mirror 530. Secondary mirror 530 reflects the light ray in the direction L′, toward spindle 470. After final assembly, the space occupied by spindle 470 will be occupied, instead, with a concentrating rod and photovoltaic cell, as discussed below. Other light rays (not shown) emanating toward the primary mirror are similarly reflected from the primary mirror to the secondary mirror and toward the position occupied by spindle 470 of FIG. 5B. Note that light ray 412's path is only a symbolic example for illustration purposes. An accurate description of the operation of optical elements in a particular embodiment is provided in the related applications. To complete the array assembly, additional components are placed into alignment with the optical elements. The additional components are part of a back pan assembly deposited with a back pan tool 600, as shown in FIG. 6. The array is now shown upside-down from its orientation in the previous Figures. Light entering the array emanates from a point such as L. The light is reflected by a primary mirror at LI to impinge a secondary mirror at L2 to be reflected in a direction L′ toward a photovoltaic cell in an element of the back pan assembly.

In a particular embodiment, the back pan tool is aligned with and deposited onto glass sheet 200 in the direction B-B′ in a manner similar to the operation of the assembly tool described above. For example, tabs (not shown) can be used to register with the actuators and pillar faces. Each element of the back pan assembly includes components such as an integrating rod, photovoltaic cell, copper heat transfer, metal back panel and other items that are described in the related patent applications, referenced above. An adhesive system, such as a laminate adhesive seal spacer process, is used to secure the back pan assembly to the glass sheet. This is an environmental seal and then a structural adhesive is added to hold the glass to the back pan. Any other suitable method can be used to join the back panel assembly to the glass sheet.

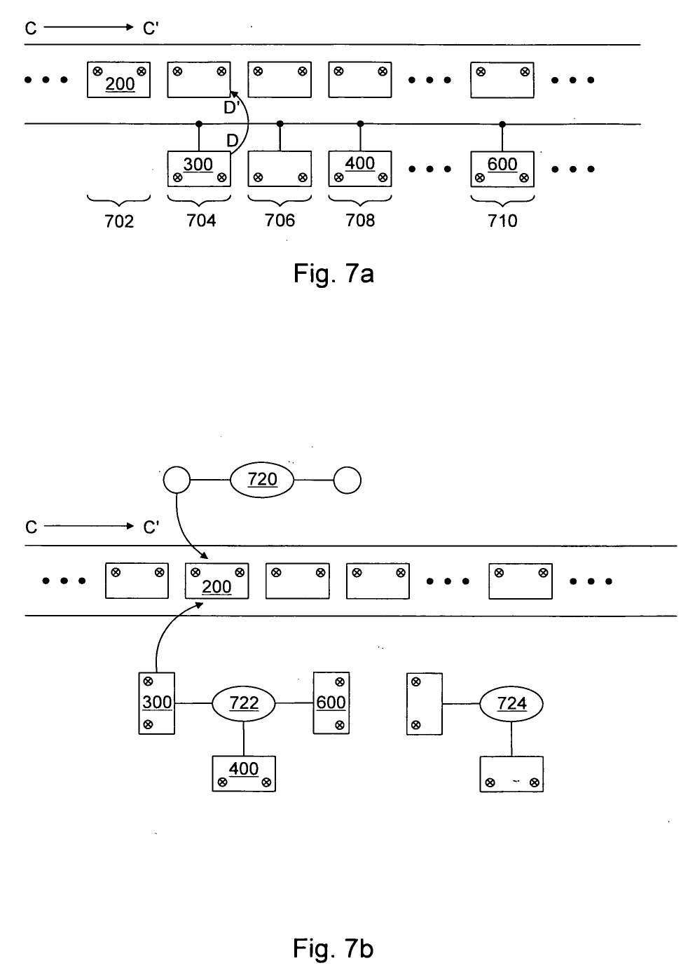

FIG. 7A illustrates an optical registration method for a sequential assembly line process of fabrication. Glass sheets such as glass sheet 200 are conveyed down the line in the direction C-C′. At stage 702 a glass sheet without any processing is shown. At stage 704, template tool 300 can be positioned upon a glass sheet by moving the template tool in the direction D-D′. Registration is performed using the marks shown on the glass sheet and the template tool. Adhesive for the secondary mirrors and the primary mirrors is deposited on the glass sheet.

In a similar manner to stage 704, stage 706 deposits the secondary mirrors. At stage 708, assembly tool 400 is used to deposit the primary mirrors. Other steps can be performed at different stages as desired (not shown). At stage 710, back pan tool 600 is used to deposit the back pan assembly and complete the array. It should be apparent that stages can be modified from those shown in this example. Implementation of each stage can vary and manual, automatic or a combination of manual and automatic acts can be used. The illustration is merely a simplified schematic to indicate basic steps in an assembly line process by which an optical array can be fabricated.

FIG. 7B illustrates an optical registration method for a robotic assembly line. Robot tool stations such as 720 and 722 are used to position tools such as 300, 400 and 600 onto glass sheets such as 200 by moving the tools onto the sheets. Robot component stations such as 720 are used to deposit components such as secondary mirrors onto a sheet. The array can be completed at one or more robot stations as the sheet moves along the line. Additional stations such as 724 can be used to perform other acts, as desired. Again, any combination of manual, automatic or manual and automatic acts can be used together with the robotic station assembly approach.

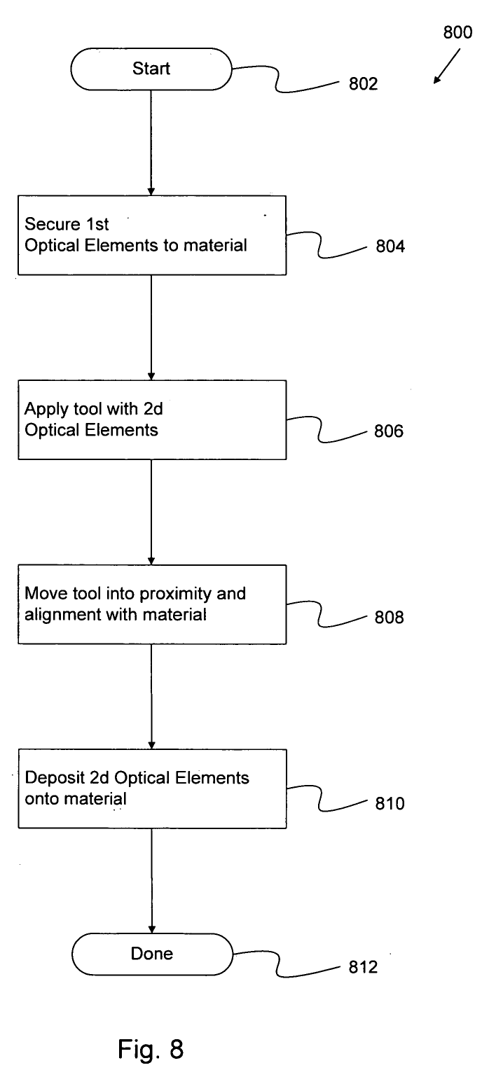

FIG. 8 is a simplified flowchart illustrating basic steps in a fabrication process for an array of aligned optical elements. In FIG. 8, flowchart 800 is entered at 802. Step 804 is first performed to secure first optical elements (e.g., secondary mirrors) to a material such as a sheet of glass. Next step 806 is performed to apply a tool with second optical elements (e.g., primary mirrors).

Next, the tool is moved into proximity and alignment with the material in step 808. Step 810 is then performed to deposit the second optical elements onto the material.

Although embodiments of the invention have been discussed primarily with respect to specific embodiments thereof, other variations are possible. For example, it may be possible to use non-planar materials and surfaces with the techniques disclosed herein. Other embodiments can use optical or other components for focusing any type of electromagnetic energy such as infrared, ultraviolet, radio-frequency, etc. There may be other applications for the fabrication method and apparatus disclosed herein, such as in the fields of light emission or sourcing technology (e.g., fluorescent lighting using a trough design, incandescent, halogen, spotlight, etc.) where the light source is put in the position of the photovoltaic cell. In general, any type of suitable cell, such as a photovoltaic cell, concentrator cell or solar cell can be used. In other applications it may be possible to use other energy such as any source of photons, electrons or other dispersed energy that can be concentrated. Other applications are possible.

Lenses or other optical devices might be used in place of, or in addition to, the primary and secondary mirrors or other components presented herein. For example, a Fresnel type of lens could be used to focus light on the primary optical element, or to focus light at an intermediary phase after processing by a primary optical element.

Steps may be performed by hardware or software, as desired. Note that steps can be added to, taken from or modified from the steps in this specification without deviating from the scope of the invention. In general, any flowcharts presented are only intended to indicate one possible sequence of basic operations to achieve a function, and many variations are possible.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein the various databases, application software or network tools may reside in one or more server computers and more particularly, in the memory of such server computers. As used herein, “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nano-engineered systems, components and mechanisms may be used.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. An apparatus for aligning optical components in an array, the apparatus comprising:
a planar sheet;
a first set of through holes in the planar sheet, wherein the through holes in the first set are used to position secondary mirrors onto a surface by using the planar sheet as a template; and
a second set of through holes in the planar sheet, wherein the second set of through holes includes groups of through holes, wherein each group of through holes is associated with a different hole in the first set, wherein the through holes in a particular group in the second set are used to position adhesive patches in a predetermined relationship to a corresponding secondary mirror placed onto the surface using the planar sheet.

2. The apparatus of claim 1, wherein the surface is comprised of optically transparent material.

3. The apparatus of claim 1, wherein the adhesive patches are used to secure a primary mirror to the surface.

4. The apparatus of claim 3, wherein the particular primary mirror reflects sunlight onto the corresponding secondary mirror.

5. The apparatus of claim 4, wherein the corresponding secondary mirror reflects the sunlight onto a photovoltaic cell.

6. The apparatus of claim 1, wherein the planar sheet is registered with the surface by using an external tool.

7. The apparatus of claim 1, further comprising:
one or more registration marks for optically aligning the planar sheet with the material.

8. An apparatus for aligning optical components in an array, the apparatus comprising:
a first registration mechanism for registering a material having a surface, wherein the first registration mechanism also provides for registering a template in alignment with the material, wherein the template provides for depositing a plurality of first optical elements and for determining a mounting position for a plurality of second optical elements; and
a second registration mechanism for registering an assembly in alignment with the material, wherein the assembly deposits the second optical elements in a predetermined alignment with at least one first optical elements according to the determined mounting positions.

9. The apparatus of claim 8, wherein the first registration mechanism includes a corner of the apparatus.

10. The apparatus of claim 8, wherein the first registration mechanism includes an edge of the apparatus.

11. The apparatus of claim 8, wherein the second registration mechanism includes a pillar having a face, wherein registration uses the face.

12. The apparatus of claim 11, wherein the second registration mechanism includes an actuator for selectively lowering the assembly into proximity with the material.

13. An apparatus for aligning an array of optical elements, the apparatus comprising:
means for selectively holding a plurality of primary mirror to the apparatus;
means for registering the plurality of primary mirrors to a plurality of secondary mirrors.

14. The apparatus of claim 13, wherein the apparatus is substantially rectangular, wherein the means for registering includes:
three tabs at three different edges of the apparatus, wherein the tabs each have an edge that is used for registering the plurality of primary mirrors to the plurality of secondary mirrors.

15. The apparatus of claim 13, wherein the means for selectively holding includes selective application of a low pressure area to a surface of each primary mirror.

16. An apparatus for aligning optical components for use in a photovoltaic array, the apparatus comprising:
a base tool for receiving a sheet of material;
a template tool for depositing a plurality of secondary mirrors onto the sheet of material and for depositing adhesive patches onto the sheet of material for securing primary mirrors, wherein each primary mirror is associated with a different one of the secondary mirrors; and
an assembly tool for selectively holding the primary mirrors, wherein the base tool includes a mechanism to bring the assembly tool into alignment with the sheet of material.

17. The apparatus of claim 16, wherein the sheet of material includes a glass sheet.

18. The apparatus of claim 17, wherein the assembly tool uses low pressure areas to selectively hold the primary mirrors.

19. The apparatus of claim 16, further comprising one or more actuators for selectively bringing the assembly tool into alignment with the sheet of material.

20. The apparatus of claim 16, further comprising one or more registration marks on the sheet of material for aligning at least one of the tools.
